(19) United States
(12) Patent Application Publication
(10) Pub. No.: US 2024/0059264 A1
(43) Pub. Date: Feb. 22, 2024

(54) METHOD FOR OPERATING A CONTROL SYSTEM OF A VEHICLE WITH A STEERING BRAKE FUNCTION AND TRACTION CONTROL SYSTEM

(71) Applicant: Knorr-Bremse Systeme Fuer Nutzfahrzeuge GmbH, Muenchen (DE)

(72) Inventors: Jonas Leibbrand, Niefern-Oeschelbronn (DE); Andreas Ziegler, Weissach (DE)

(21) Appl. No.: 18/259,709

(22) PCT Filed: Jan. 21, 2022
(86) PCT No.: PCT/EP2022/051381

§ 371 Date: Jun. 28, 2023

(30) Foreign Application Priority Data
Feb. 4, 2021 (DE) 10 2021 102 575.3

(51) Int. Cl. B60T 8/1755; B60W 30/18

(52) U.S. Cl. CPC B60T 8/1755; B60W 30/18145; B60W 30/18172; B60T 2270/303

(57) ABSTRACT

A method for operating a vehicle-control-system, including: a) controlling, by a drive-control-system (DCS), a drive motor (DM) driving at least one driven-axle (HA) having first/second drive-wheels (DW), b) driving, via the DM, a differential-gear, between first/second DWs, c) controlling, by a brake-control-system (BCS), a brake-device (BD) having first/second brake-actuators (BA) for first/second DWs, d) providing a steering-brake-function (SBF), with which steering is provided by selectively controlling the first/second BAs of the HA, e) guiding, via a traction-control-system (ASR), an inadmissible drive-slip (DS) at the first/second DWs of the HA to a permissible DS by engaging: e1) in the drive-control of the DM, wherein the DM's drive-power is reduced, and/or by e2) in the BCS of the BD, wherein a DW having inadmissibly great DS, is selectively braked by the first/second DWs; f) dispensing with engagement in the BCS of the ASR BD, when the SBF/ASR is active/activated at the HA.

### FIELD OF THE INVENTION

The invention relates to a method for operating a control system of a vehicle and a vehicle, in particular a traction vehicle of a traction vehicle/semitrailer combination, having a control system which is controlled by such a method.

### BACKGROUND INFORMATION

There are control systems of vehicles having a traction control system (ASR), wherein the drive slip of wheels of a driven axle is controlled with respect to a permissible drive slip if at least one of the driven wheels has a drive slip which exceeds the permitted drive slip. Such a traction control system (ASR) can selectively reduce the speed of driven wheels by engaging in a brake control system of a brake device of the vehicle and engaging in the drive control system of a drive motor of the vehicle in order to reduce inadmissibly high drive slip.

In addition, there are control systems of vehicles with a steering brake function, with which simply by selectively braking wheels a steering effect can be applied to the vehicle. Furthermore, there are known differential gear mechanisms on driven axles, so-called axle differentials, which ensure compensation for the speeds between the two wheels of the driven axle.

### SUMMARY OF THE INVENTION

An object of the invention is to provide a method for operating a control system of a vehicle with traction control and with a steering brake function, wherein the steering effect, which is brought about by the steering brake function, is as great as possible. Furthermore, a vehicle having a steering system which is operated according to such a method is also intended to be provided.

This object may be achieved according to the features of the embodiments as described herein.

The invention is based on the recognition that, if the steering brake function is active or has been activated so that the vehicle carries out travel round a bend, and to this end the drive wheel which is on the inside of the bend is braked but not the drive wheel, which is on the outside of the bend, of the driven axle, an acceleration of the wheel which is on the outside of the bend and which then has an increased drive slip, which is inadmissibly high under some circumstances, is brought about at the driven axle by the differential gear mechanism (which is not blocked). Simply in order to be able to achieve bend radii which are as small as possible by the steering brake function, however, this behavior is desirable. However, the ASR control would then brake the wheel which is on the outside of the bend to the permitted drive slip by engaging in the brake control of the brake device, which would again reduce the steering effect and increase the bend radius.

In order to solve this problem, the invention proposes a method for operating a control system of a vehicle which has at least the following:
a) a drive motor which is controlled by a drive control system and which drives at least one driven axle having a first drive wheel and a second drive wheel,
b) a differential gear mechanism between the first drive wheel and the second drive wheel,
c) a brake device which is controlled by a brake control system and which has a first brake actuator for the first drive wheel and a second brake actuator for the second drive wheel,
d) a steering brake function, with which a steering action on the vehicle can be achieved by selectively controlling the first brake actuator and/or the second brake actuator of the at least one driven axle,
e) a traction control system, with which an inadmissible drive slip at the first drive wheel and/or at the second drive wheel of the at least one driven axle can be guided back to a permissible drive slip by
e1) engaging in the drive control of the drive motor, wherein the drive power of the drive motor is reduced, and/or by
e2) engaging in the brake control of the brake device, wherein a drive wheel which has inadmissibly great drive slip, is selectively braked by the first drive wheel and/or the second drive wheel, wherein,
f) if the steering brake function is active or has been activated at the at least one driven axle and if the traction control system is then activated at the at least one driven axle, in the context of the traction control system the engagement in the brake control system of the brake device is dispensed with.

The term “engagement in the brake control system” is intended to be understood to mean that the brake device or components of the brake device are activated in order to bring about a brake action at at least one drive wheel. Similarly, the term “engagement in the drive control system” is intended to be understood to mean that the drive device or components of the drive device are activated in order to bring about a reduced drive action at at least one drive wheel.

Therefore, although the traction control system (ASR) of the control system is in principle constructed so that it can carry out an engagement in the drive control of the drive motor and an engagement in the brake control of the brake device in order to guide back the drive slip at the first and/or second drive wheel of the driven axle to a permitted drive slip, the engagement in the brake control system of the brake device is dispensed with, that is to say, the brake device is not activated if the steering brake function is active or has been activated at the at least one driven axle.

Then, the steering effect which is initiated or brought about by the steering brake function is not impaired by a braking, which is brought about by the traction control system, of the drive wheel which is on the outside of the bend. As a result, small radii of bends, in particular on a carriageway or on an underlying surface with a low friction coefficient, can be travelled round by the steering brake function. Furthermore, wear-promoting brake engagements of the traction control system can also thereby be avoided, which brake engagements can also be brought about in that the drive train braces.

If the steering brake function is active or has been activated at the at least one driven axle and if the traction control system is then activated at the at least one driven axle, however, in the context of the traction control system the engagement in the drive control system of the drive motor may be intended to be carried out, wherein the drive power of the drive motor is reduced. The driving stability of the vehicle is thereby advantageously improved.

As set out above, the differential gear mechanism is in the form of an axle differential which ensures compensation of the speeds between the two drive wheels of the driven axle.

The differential gear mechanism can be configured with or without a differential lock or also with a switchable differential lock. A (switched on) differential lock provides a rigid drive connection between the first drive wheel and the second drive wheel so that the speeds of the two drive wheels are identical, while, with the differential lock switched off or with a differential gear mechanism without any differential lock, no rigid drive connection is present.

The control system which is operated in accordance with the method according to the invention may be intended to have a differential gear mechanism without a differential lock or a differential gear mechanism with a differential lock, in which during operation according to the invention the differential lock is switched off so that the problem which is explained above in connection with the invention actually occurs.

Advantageous developments of the invention are set out in the dependent claims.

For safety reasons, in the context of the traction control system the engagement in the brake control of the brake device can be dispensed with only when the travel speed of the vehicle is less than a predetermined limit speed (v<v_{grenz}).

The control system can also further comprise
a) a steering device, which can be actuated in particular by a driver of the vehicle, and/or
b) an autonomous vehicle control system and/or
c) at least one driver assistance system
by which a steering request signal, by which travel of the vehicle round a bend is intended to be brought about can be generated.

The steering request signal can be generated, for example, by the autonomous vehicle control system and/or the driver assistance system if it has been established that the steering device which is actuated by the driver of the vehicle has a fault or a defect. Then, the autonomous vehicle control system and/or the driver assistance system is/are used as redundancy for the failed steering device.

The steering brake function can be activated at the at least one driven axle particularly in response to the steering request signal, that is to say, started. In particular, the steering request signal of the autonomous vehicle control system and/or the driver assistance system is used to steer the vehicle if it has been established that the steering device has a fault or a defect. The steering request signal is then converted by steering/braking, that is to say, by the steering brake function at least at the at least one driven axle (HA). In addition, the steering/braking can naturally also be carried out at a non-driven axle, for example, at a steered front axle.

During steering/braking, of the first drive wheel and the second drive wheel of the drive axle the drive wheel which constitutes the drive wheel which is on the inside of the bend with respect to the travel round a bend represented by the steering request signal may then be braked. In this case, the drive wheel which is different from the drive wheel which is on the inside of the bend may not be braked.

In a similar manner, during steering/braking of a first non-driven wheel and a second non-driven wheel of a non-driven axle (for example, a non-driven front axle), the wheel which constitutes the wheel which is on the inside of the bend with respect to the travel round a bend represented by the steering request signal may be braked. In this case, the wheel which is different from the wheel which is on the inside of the bend may not be braked.

In particular, an electric/pneumatic and electronically controlled brake system (EBS) with a two-channel pressure control module or with two one-channel pressure control modules, a first one-channel pressure control module and a second pressure control module, can be used as the brake device at the at least one driven axle, wherein by a first channel of the two-channel pressure control module or the first one-channel pressure control module a first brake pressure can be individually controlled for the first brake actuator and by a second channel of the two-channel pressure control module or the second one-channel pressure control module a second brake pressure of the second brake actuator can be individually controlled. Since the first brake actuator and the second brake actuator are then controlled by a respective channel of a pressure control module, a braking of the first drive wheel and the second drive wheel of the drive axle in an individual manner for each wheel is therefore possible in the context of the steering brake function. Under the above-mentioned prerequisites, braking of the first drive wheel and the second drive wheel of the drive axle in an individual manner for each wheel can then also be carried out in the context of the traction control system.

The traction control system can also be automatically activated if an inadmissible drive slip at the first drive wheel and/or at the second drive wheel of the at least one driven axle has been established.

The invention also relates to a vehicle, in particular a traction vehicle of a traction vehicle semitrailer combination with a control system, which is controlled by a method according to any one of the preceding claims.

One embodiment of the invention is illustrated below in the drawings and explained in greater detail in the following description.

### BRIEF DESCRIPTION OF THE DRAWINGS

FIG. 1 shows a schematic circuit diagram of an electric/pneumatic brake device as part of an exemplary embodiment of a control system of a traction vehicle of a traction vehicle/semitrailer combination.

FIG. 2 shows a schematic circuit diagram of the control system of the traction vehicle of a traction vehicle/semitrailer combination.

FIG. 3 shows a schematic circuit diagram of an electromechanical steering device as part of the exemplary embodiment of the control system of a traction vehicle of a traction vehicle/semitrailer combination.

FIG. 4 shows a flow chart of an exemplary embodiment of a method for operating the control system.

### DETAILED DESCRIPTION

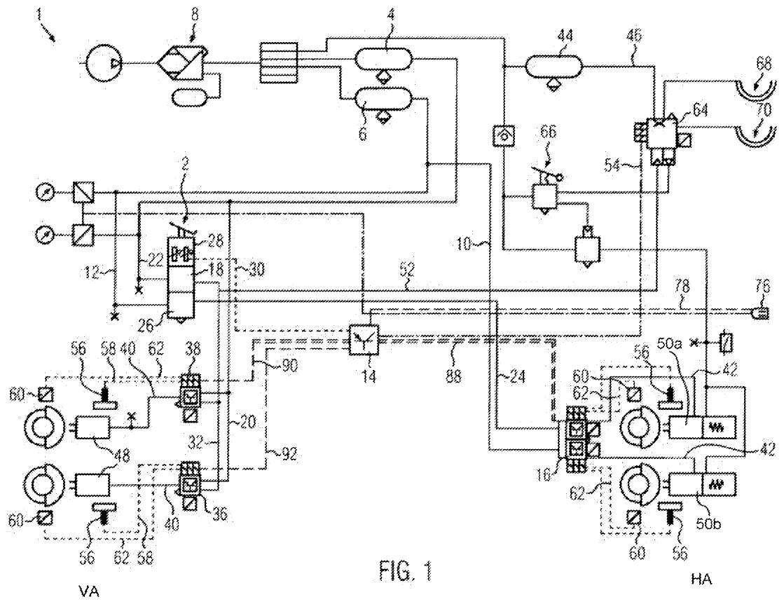

FIG. 1 schematically illustrates a service brake device 1 as part of an exemplary embodiment of a control system 300 of a traction vehicle of a traction vehicle/semitrailer combination. In the present case, the traction vehicle/semitrailer combination has a two-axle semitrailer, but a drawbar trailer or a plurality of drawbar trailers can also be suspended on the traction vehicle. In this case, for example, the service brake device 1 of the traction vehicle is formed by an electric/pneumatic friction brake system in the form of an electronically controlled brake system (EBS; Electronic Brake System).

In such an electronically controlled brake system (EBS), pressure control modules 16, 36, 38 are provided for each axle or wheel, with integrated inlet valves, outlet valves and backup valves, and with pressure sensors for detecting the actual brake pressure and with a superordinate electronic control system for compensating for the actual brake pressures with the desired brake pressures according to the respective brake requirement. The electronically controlled brake system (EBS) of the traction vehicle further contains an anti-lock braking system (ABS), the ABS control routines of which may be integrated in a central brake control device 14. Furthermore, in the traction vehicle a traction control system (ASR) and an electronic stability program (ESP) may be provided here, wherein the control routines in this regard are also implemented in the central brake control device 14.

According to the circuit diagram, shown in FIG. 1, of the electric/pneumatic service brake device 1 of the traction vehicle, a footbrake value transmitter 2, a front axle storage pressure container 4 for supplying a front axle pressure circuit or front axle pressure channel and a rear axle storage pressure container 6 for supplying a rear axle pressure circuit or rear axle pressure channel are provided. The air provision, air preparation and the protection are carried out as prescribed by law by an air preparation module 8 which is not described in greater detail here.

The rear axle storage pressure container 6 is connected via pneumatic supply lines 10, 12, on the one hand, to a storage connection of a two-channel pressure control module 16 for the brake cylinders 50 of the rear axle and to a rear axle footbrake valve 26 of the footbrake value transmitter 2. In a similar manner, the front axle storage pressure container 4 is connected via pneumatic supply lines 20, 22 to storage connections of two one-channel pressure control modules 36, 38 which are associated with a brake cylinder 48 of a front wheel, and to a front axle footbrake valve 18 of the footbrake value transmitter 2. The footbrake value transmitter 2 therefore comprises two pneumatically acting footbrake valves 18, 26 which generate a pneumatic backup pressure or control pressure at the outlets of the footbrake valves 18, 26 in accordance with a brake request which is predetermined by the foot of the driver on a brake pedal. In a manner parallel therewith, an electric front axle channel and an electric rear axle channel are constructed in the footbrake value transmitter 2, in a state combined in an electric channel 28, and control in accordance with the brake request an electric brake request signal in an electrical connection, which may be in the form of a brake data bus 30, between the electric channel 28 of the footbrake value transmitter 2 and the central electronic brake control device 14, which can differentiate between the two brake request signals which are different, for example, for load reasons, for the front axle and the rear axle. Furthermore, the front axle footbrake valve 18 and the rear axle footbrake valve 26 of the footbrake value transmitter 2 are each connected via a pneumatic control line 24, 32 to associated backup connections of the two-channel pressure control module 16 or the one-channel pressure control modules 36, 38. Furthermore, a respective pneumatic brake line 40, 42 leads from working pressure connections of the two-channel pressure control module 16 or the two one-channel pressure control modules 36, 38 to the brake cylinders 48, 50 of the front axle or the rear axle for each wheel.

Speed sensors 56 report the current speed of the wheels of the two-axle vehicle via electric signal lines 58 to the central brake control device 14. Similarly, wear sensors 60 may be provided for each wheel brake and report signals via electric signal lines 62 to the central brake control device 14 in accordance with the current brake wear.

Furthermore, there is provided a trailer control module 64 which is supplied via a supply line 46 with compressed air, on the one hand, with a trailer storage pressure container 44 which is on the traction vehicle and, on the other hand, is controlled by pneumatic control pressure, for example, of the front axle footbrake valve 18 of the footbrake value transmitter 2 via a control line 52 pneumatically by backup pressure. Furthermore, the trailer control module 64 also receives an electrical signal from the central brake control device 14 via an electrical control line 54. Finally, the trailer control module 64 is further controlled by a parking brake unit 66 which is not of any interest here.

The trailer control module 64 typically contains an inlet solenoid valve and an outlet solenoid valve and a backup solenoid valve for controlling the pressure of a similarly integrated relay valve which is supplied with compressed air by the trailer compressed air store 44 in order to control a control pressure for a coupling head “brake” 70 in accordance with a control signal which is introduced via the electrical control line 54 via these solenoid valves and the relay valve. In this case, the relay valve modulates the control pressure for the coupling head “brake” 70 from the storage pressure, which is applied to the storage connection thereof, of the trailer storage pressure container 44 in accordance with the control pressure which is formed by the solenoid valves. By an integrated pressure sensor, this control pressure is measured for the coupling head “brake 70” and reported to the central brake control device 14. If this primary electrical control unit fails, the integrated backup valve is connected and the relay valve is controlled by the pneumatic control pressure, which is guided in the control line 52, of the front axle brake circuit. Finally, the trailer control module 64 loops through the compressed air which comes from the trailer compressed air store 44 under storage pressure to a coupling head “store” 68 of the trailer vehicle. The construction and the functions of such an electric/pneumatic trailer control module 64 are adequately known and therefore do not need to be explained in greater detail here.

The brake application devices of the rear axle may be in the form of known combination cylinders, that is to say, a combination of an active service brake cylinder 50 and a passive spring-loaded brake cylinder. The term “active” means in this context that the service brake cylinders 50 clamp shut when supplied with air and are released when vented and the term “passive” means that the spring-loaded brake cylinders clamp shut when vented and are released when supplied with air. At the wheels of the front axle, however, only active service brake cylinders 48 are provided.

The electric/pneumatic two-channel pressure control module 16 which is in the form of a structural unit has two separately controllable pressure control channels, wherein for each pressure control channel on the basis of storage air, which comes from the rear axle compressed air store 6, a controlled operating pressure which is applied to the respective operating pressure connections for the brake cylinders 50 of the rear axle is produced in accordance with the brake request signal of the footbrake value transmitter 2 and is measured by the integrated pressure sensors in order to adapt or regulate the measured actual brake pressure to the desired brake pressure according to the brake requirement. In a similar manner, in each one-channel pressure control module 36, 38 of the front axle, the brake pressure is controlled individually for the two brake cylinders 48 of the wheels of the front axle.

In order to form pressure control channels which are pneumatically separated in terms of the circuit (for example here: front axle pressure control channel or rear axle pressure control channel), consequently, an individual compressed air store 4, 6 is associated with each pressure control channel, wherein the pneumatic flow paths of each pressure control channel are constructed in a pneumatically separate manner from the pneumatic flow path of another pressure control channel from the associated compressed air store 4, 6 via the associated pressure control modules 16, 36, 38 as far as the associated brake application devices 48, 50a, 50b. In this instance, the brake application devices 48 of the front axle are in the form of active pneumatic service brake cylinders 48 and the brake application devices 50a, 50b of the rear axle are in the form of combined service brake and spring-loaded brake cylinders, with an active service brake portion and a passive spring-loaded brake portion.

In this case, a first drive wheel of the rear axle which may be driven here is braked by a first brake application device 50a and a second drive wheel of the rear axle is braked by a second brake application device 50b.

In order to form an electric/pneumatic brake system with primarily electrically actuated pressure control channels (front axle pressure control channel or rear axle pressure control channel) and a subordinate pneumatic fall-back level in the event of failure of the electric system, particularly which may be an individual backup circuit with an individual backup valve is associated with each pressure control module 16, 36, 38 for controlling a pneumatic backup or control pressure which is derived from the storage pressure of the compressed air store 4, 6 which is associated with the respective pressure control circuit of the rear axle or front axle and which is formed by the footbrake value transmitter 2, and from which in the event of a failure of electrical components the respective brake pressure at the working pressure connections of the pressure control modules 16, 36, 38 is formed.

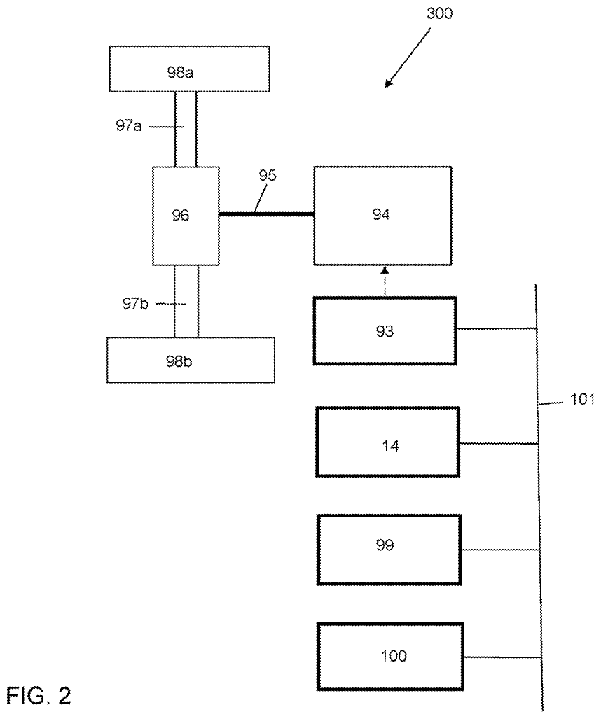

The service brake device 1 of the traction vehicle and the brake device of the semitrailer are, as is conventional in such brake systems, connected to each other by a coupling head “store” 68 and by a coupling head “brake” 70. In this case, the store pressure which is introduced by the traction vehicle is guided in the semitrailer in a store pressure line 72 which is on the semitrailer and which is shown in FIG. 2 and the control or brake pressure which is introduced from the traction vehicle is guided in the semitrailer in a control pressure line 74 which is on the semitrailer. Since the semitrailer control module 64 does not have any individual electronic control device, the electrical brake control signals must be transmitted from the central brake control device 14 via a CAN-BUS “semitrailer” 78 and an electronic semitrailer interface 76 to the semitrailer if it has an electric/pneumatic brake system, which is not the case here, however. As a result of the absence of an electric/pneumatic brake system in the semitrailer, therefore, no transmission of electrical brake control signals takes place from the traction vehicle to the semitrailer. The semitrailer control module 64 and the two-channel pressure control module 16 and the two one-channel pressure control modules 36, 38 are each controlled via an electrical control line 54, 88, 90, 92 by the central brake control device 14.

Against this background, the operation of the brake apparatus is as follows. In a normal braking operation, the driver actuates the brake pedal and therefore the footbrake value transmitter 2, whereby in the electric channel 28 an electrical brake request signal is generated similarly to the desired intended deceleration and is introduced into the central brake control device 14 which subsequently controls via the electrical control lines 54, 88, 90, 92 the semitrailer control module 64, the two-channel pressure control module 16 and the two one-channel pressure control modules in accordance with the brake request signal and where applicable in accordance with additional parameters, such as the respective loading. In this case, the integrated inlet solenoid valves, outlet solenoid valves and where applicable backup solenoid valves which are usually in the form of 2/2-path solenoid valves, are switched in accordance with the brake request so that they pneumatically control the similarly integrated relay valves in order to introduce a desired brake pressure or desired control pressure which corresponds in accordance with the brake request into the relevant brake application devices 48, 50a, 50b of the traction vehicle and, in the semitrailer, into the semitrailer control valve 80 which modulates the brake pressure for the brake cylinders 84 of the semitrailer from the desired control pressure. The pressure sensors which are integrated in the pressure control modules 16, 36 and 38 and in the semitrailer control module 64 then report the actual brake pressure or actual control pressure to the central brake control device 14 which subsequently controls the desired brake pressure or desired control pressure by controlling the solenoid valves at the module side. In the central brake control device 14, routines of a traction control system (ASR), an anti-lock braking system (ABS) and optionally also an electronic drive dynamics control (ESP) and an adaptive speed control (ACC) are implemented.

If the brake request signal for the central brake control device 14 is generated, instead of by the footbrake value transmitter 2, by a driver assistance system, such as, for example, the traction control system (ASR), an electronic drive dynamics control (ESP) or an adaptive speed control (ACC), the same functions as described above are carried out.

If the brake slip of a wheel or a plurality of wheels of the traction vehicle exceeds a predetermined brake slip limit of, for example, from 12% to 14%, which can be determined via the wheel speed sensors 56, the brake slip control system or the ABS of the traction vehicle responds. In this case, the brake pressures for the traction vehicle are adjusted via a corresponding control of the solenoid valves in the pressure control module 36, 38 which is associated with the wheel with brake slippage or in the pressure control module 16 which is associated with the wheels with brake slippage by the ABS routines which are implemented in the central brake control device so that the brake slippage control differential is regulated.

FIG. 2 shows a schematic circuit diagram of the control system 300 of the traction vehicle of the traction vehicle/semitrailer combination. The control system 300 comprises as a component of the electronically controlled brake system (EBS) 1 the central brake control device 14 and an electronic drive control device 93 of a drive device of the traction vehicle. The drive device comprises in this case, for example, a motor/gear mechanism unit 94 which drives a differential gear mechanism 96 via a central drive shaft 95. First and second drive shafts 97a, 97b which then drive the first and second drive wheels 98a, 98b of the rear axle HA branch off from the differential gear mechanism 96.

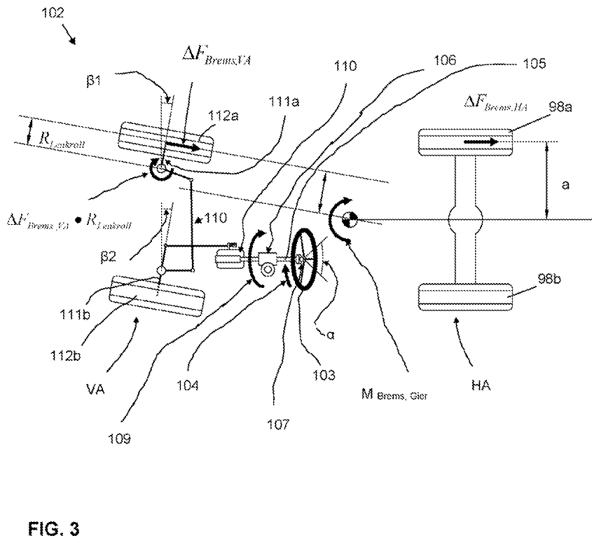

The control system 300 further comprises a steering device 102 which is, for example, electromechanical in this case and which is illustrated in detail in FIG. 3. The electromechanical steering device 102 comprises an electronic steering control device 99, the function of which will be described in greater detail below.

The steering control device 99, the central brake control device 14, the drive control device 93 and an electronic control device 100 of an autonomous vehicle control system and/or a driver assistance system are, for example, connected to a vehicle data bus 101 which is, for example, a CAN. The steering control device 99, the central brake control device 14, the drive control device 93 and the electronic control device 100 can thereby exchange data and control signals with each other. In particular, the central brake control device 14 can control the drive control device 93 in order, for example, to reduce the drive power of the motor 94 in the context of the traction control system (ASR). It is also thereby possible for the electronic control device 100 to control the central brake control device 14 and/or the drive control device 93 and/or the steering control device 99 so that braking, steering and/or steering/braking of the traction vehicle is carried out.

For steering/braking, a steering/braking function is implemented as a routine, for example, in the central brake control device 14, wherein in this case the steered wheels 112a, 121b of the front axle VA and/or the drive wheels 98a, 98b of the rear axle HA can be braked selectively in order to achieve a desired steering effect on the traction vehicle. This operation is described in greater detail below.

The steering device 102 which is, for example, electromechanical is illustrated in detail in FIG. 3. The steering wheel torque 104 which is applied by the driver via the steering wheel 103 is introduced via a steering spindle 105 into an electrical steering actuator 106 which is formed, for example, by an electric motor. At the steering spindle 105, there is further arranged a steering wheel torque sensor 107 which detects the respective steering wheel torque 104 which is applied by the driver via the steering wheel 103 and which is introduced as a steering wheel torque signal into the electronic steering control device 99 which is connected to the vehicle data bus 101 (FIG. 2).

The steering control device 99 can in principle control the steering actuator 106 in accordance with the steering wheel torque 104 which is detected at the steering wheel 103 in order to generate an additional superimposed torque with respect to the steering wheel torque 104 which is applied by the driver at the steering spindle 105. Therefore, the steering device 102 constitutes in this instance, for example, a so-called superimposed steering with steering torque superimposition. Instead of the steering wheel torque 104 or in addition thereto, the respective steering wheel angle α can also be detected by a steering wheel angle sensor so that a superimposed steering with steering wheel angle superimposition would then be present.

However, the steering actuator 106 can also generate a steering torque 109 at the steering spindle 105 without any action of the driver, that is to say, without actuation of the steering wheel 103. The steering actuator 106 can also not introduce any steering torque 109 into the steering spindle 105 so that the steering forces are derived merely by the steering wheel torque 104 which is generated by the driver. Then, the steering request is issued only by the driver who accordingly actuates the steering wheel 103.

The steering spindle 105 opens in a steering gear mechanism 110 which in this instance may be a hydraulic servo-support and reinforces the steering wheel torque 104 or the steering torque 109. The steering gear mechanism 110 then controls via a steering linkage 110 axle members 111a, 111b of the first and second front wheel 112a, 112b of the steered front axle VA in order to adjust a steering angle 131 and 132 for right and left at that location. The rear axle HA may be not steered in this instance.

For example, the steering torque 109 which acts on the steering spindle 105 can be generated exclusively by the steering actuator 106 as a result of it being controlled by the electronic steering control device 99 which, for example, receives from the electronic control unit 100 in the context of an autonomous vehicle control system and/or a driver assistance control a steering request which is transmitted by the vehicle data bus 101 as a steering request signal.

It is also possible to conceive a situation in which a steering wheel torque 104 which is applied by the driver via the steering wheel 103 to the steering spindle 105 is superimposed on a steering torque 109 which is applied by the steering actuator 106.

By a so-called steering/braking action, in the context of a steering/braking function a yaw torque M_{Brems,Gier} which causes the traction vehicle to follow in this instance, for example, a left-hand bend path, can be generated by selective braking in this instance, for example, of the first drive wheel 98a (which is then on the inside of the bend) on the rear axle HA and a first steered wheel 112a (which is then on the inside of the bend) on the front axle VA. The important aspect for the yaw torque M_{Brems,Gier} is the steering roll radius R_{Lenkroll} at the first steered front wheel 112a which generates a brake torque ΔF_{Brems,VA}·R_{Lenkroll} in conjunction with the brake force DF_{Brems,VA} which is active there, furthermore half of the axle length a which generates a brake torque ΔF_{Brems,HA}·a in conjunction with the brake force ΔF_{Brems,HA} at the first drive wheel 98a of the rear axle HA. In total, a yaw torque M_{Brems,Gier} is then active as a result of the steering/braking:

M_{Brems,Gier}=ΔF_{Brems,VA}·R_{Lenkroll}+ΔF_{Brems,HA}·a

The steering/braking function is, for example, implemented in this case in the central brake control device 14 which then causes, as a result of a selective control of the channels of the pressure control module 36, 38 and 16, an individual braking here, for example, of the first drive wheel 98a by applying the associated brake application device 50a and the first steered front wheel 112a by applying the associated brake application device 48. The steering/braking request for the steering/braking is produced here, for example, by the electronic control unit 100 and transmitted via the vehicle data bus 101 to the central brake control device 14.

The traction control system (ASR) is, for example, automatically activated when an inadmissible drive slip at the first drive wheel and/or at the second drive wheel of the rear axle HA has been established. The inadmissible drive slip is established on the basis of the signals of the speed sensors 56 at the first drive wheel 98a and/or at the second drive wheel 98b by the central brake control device 14 on the basis of the wheel speed signals which the speed sensors 56 supply and report to the central brake control device 14. In principle, the central brake control device 14 can then control the two-channel pressure control module 16 in order to activate the service brake portion of the first brake application device 50a of the rear axle HA and/or the service brake portion of the second brake application device 50a of the rear axle in order to brake the first drive wheel 98a and/or the second drive wheel 98b of the rear axle HA so that an inadmissible drive slip which may be present at that location is guided back to a permitted drive slip. Additionally or alternatively, as already set out above, to this end the central brake control device 14 can also control the drive control device 93 in order to reduce the drive power of the motor 94 in the context of the traction control system (ASR), which again results in a smaller drive slip of the two drive wheels 98a, 98b.

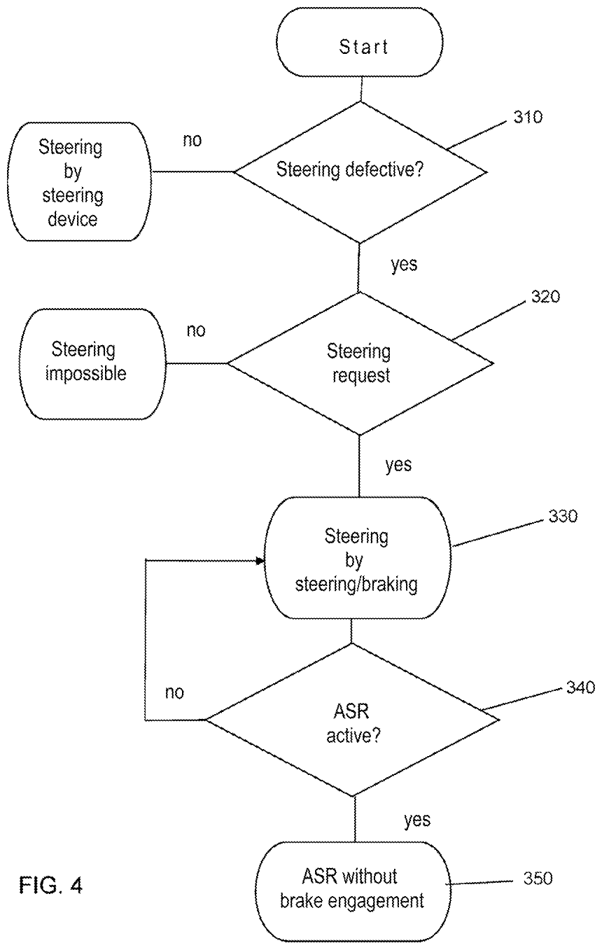

FIG. 4 now shows a flow chart of an exemplary embodiment of a method for operating the control system 300.

After the start of the method, in a first optional step 310 it is queried whether the steering device 102 has an error or a defect. The error detection can be carried out by self-monitoring or by external monitoring of the steering device 102.

If this is not the case (“no”), a steering request signal can be produced by the steering device 102 itself, that is to say, by the steering wheel 103 which is controlled by the driver and/or by the electronic steering control device 99, after which the steering effect which corresponds to the steering request signal is carried out.

If, however, it is the case (“yes”), a steering request signal can be produced or converted by the steering device 102 itself, that is to say, neither by the steering wheel 103 controlled by the driver nor by the electronic steering control device 99.

In a subsequent step 320, it is then queried whether a steering request signal which has been produced, for example, by the electronic control device 100 is present, in particular by the autonomous vehicle control system which is implemented therein and/or a driver assistance system which is implemented therein. The electronic control device 100 can be constructed so that it produces a steering request signal in the event of an error or defect being detected in the steering device 102 by the autonomous vehicle control system which is implemented therein and/or the driver assistance system which is implemented therein as a redundancy for the steering device 102.

If this is not the case (“no”), that is to say, there is no steering request signal, no steering of the traction vehicle is requested by the electronic control device 100. If, however, this is the case (“yes”), that is to say, when the electronic control device 100 has produced a steering request signal, which is possible by querying the signals which are guided on the vehicle data bus 101, the steering request signal is then converted by the steering brake function which is implemented in the central brake control device 14 in a step 330 (“steering by steering/braking”).

In a subsequent step 340, it is then queried whether the traction control system (ASR) is active or has been activated at the driven rear axle HA. This query may be carried out within the central brake control device 14, in which the traction control system (ASR) is implemented. An activation of the traction control system (ASR) at the rear axle HA is carried out if it has been established that at least one of the drive wheels 98a, 98b has inadmissibly great drive slip.

If this is not the case (“no”), the steering is carried out by steering/braking in the step 330 as described above and therefore the desired steering effect is (further) carried out until the desired steering effect has been produced, which can be achieved by a steering angle control unit. If, however, this is the case (“yes”), the traction control system (ASR) is carried out in a subsequent step 350, but an activation of the brake device 1 is dispensed with, that is to say, a selective braking of the drive wheels 98a, 98b of the rear axle HA is dispensed with, and, for example, only the drive control device 93 is controlled in order to reduce the drive power of the motor 94 in order thereby simply to reduce the drive slip at the drive wheels 98a, 98b. Brake forces which are initiated by the ASR control system and which are produced by the brake device 1, and which may have a negative effect on the steering/braking, are thereby intended to be avoided. In other words, the ASR control system is configured to reduce the drive power and to dispense with brake engagement.

The List of reference numerals is as follows:
1 Service brake device
2 Footbrake value transmitter
4 VA storage pressure container
6 HA storage pressure container
8 Air preparation module
10 Supply line
12 Supply line
14 Brake control device
16 Two-channel pressure control module
18 VA footbrake valve
20 Supply line
22 Supply line
24 Control line
26 HA footbrake valve
28 Electric channel
30 Brake data bus
32 Control line
36 One-channel pressure control module
38 One-channel pressure control module
40 Brake line
42 Brake line
44 Semitrailer storage pressure container
46 Supply line
48 Brake application device VA
50a First brake application device HA
50b Second brake application device HA
52 Control line
54 Electrical control line
56 Speed sensors
58 Electric signal lines
60 Wear sensors
62 Electric signal lines
64 Semitrailer control module
66 Parking brake unit
68 Coupling head “Store”
70 Coupling head “Brake”
72 Storage pressure line
74 Control pressure line
76 Semitrailer interface
78 Semitrailer data bus
80 Semitrailer control valve
86 Non-return valve
88 Electrical control line
90 Electrical control line
92 Electrical control line
93 Drive control device
94 Motor/gear mechanism unit
95 Drive shaft
96 Differential gear mechanism
97a First drive shaft
97b Second drive shaft
98a First drive wheel
98b Second drive wheel
99 Steering control device
100 Electronic control device
101 Vehicle data bus
102 Steering device
103 Steering wheel
104 Steering wheel torque
105 Steering spindle
106 Steering actuator
107 Steering wheel torque sensor
109 Steering torque
110 Steering gear mechanism
111a First axle member
111b Second axle member
112a First front wheel
112b Second front wheel
300 Control system

1-11. (canceled)

12. A method for operating a control system of a vehicle, the method comprising:
a) controlling, by a drive control system, a drive motor that drives at least one driven axle (HA) having a first drive wheel and a second drive wheel,
b) driving, via the drive motor, a differential gear mechanism, which is between the first drive wheel and the second drive wheel,
c) controlling, by a brake control system, a brake device that has a first brake actuator for the first drive wheel and a second brake actuator for the second drive wheel,
d) providing a steering brake function, with which a steering action on the vehicle is provided by selectively controlling the first brake actuator and/or the second brake actuator of the at least one driven axle (HA),
e) guiding, via a traction control system (ASR), an inadmissible drive slip at the first drive wheel and/or at the second drive wheel of the at least one driven axle (HA) back to a permissible drive slip by:
e1) engaging in the drive control of the drive motor, wherein the drive power of the drive motor is reduced, and/or by
e2) engaging in the brake control system of the brake device, wherein a drive wheel which has inadmissibly great drive slip, is selectively braked by the first drive wheel and/or the second drive wheel;
f) dispensing with engagement in the brake control system of the brake device for the traction control system (ASR), when the steering brake function is active or has been activated at the at least one driven axle (HA) and when the traction control system (ASR) is then activated at the at least one driven axle (HA).

13. The method as claimed in claim 12, wherein the engagement in the drive control system of the drive motor is carried out.

14. The method as claimed in claim 12, wherein, in the context of the traction control system (ASR), the engagement in the brake control of the brake device is dispensed with only when the travel speed of the vehicle is less than a predetermined limit speed.

15. The method as claimed in claim 12, further comprising:
a) a steering device, and/or
b) an autonomous vehicle control system, and/or
c) at least one driver assistance system;
wherein a steering request signal is generated by which travel of the vehicle round a bend is brought about.

16. The method as claimed in claim 15, wherein the steering request signal of the autonomous vehicle control system and/or the driver assistance system is used to steer the vehicle if it has been established that the steering device has a fault or a defect and then cannot produce a steering request signal.

17. The method as claimed in claim 16, wherein the steering request signal is converted by steering/braking at least at the driven axle (HA).

18. The method as claimed in claim 17, wherein, during steering/braking, of the first drive wheel and the second drive wheel of the drive axle (HA), the drive wheel which constitutes the drive wheel which is on the inside of the bend with respect to the travel of the vehicle round a bend represented by the steering request signal is braked.

19. The method as claimed in claim 18, wherein, during steering/braking, the drive wheel which is on the outside of the bend and which is different from the drive wheel which is on the inside of the bend is not braked.

20. The method as claimed in claim 12, wherein an electric/pneumatic and electronically controlled brake system with a two-channel pressure control module or with two one-channel pressure control modules, a first one-channel pressure control module and a second pressure control module, is used as the brake device at the at least one driven axle (HA), wherein by a first channel of the two-channel pressure control module or the first one-channel pressure control module a first brake pressure can be individually controlled for the first brake actuator and by a second channel of the two-channel pressure control module or the second one-channel pressure control module a second brake pressure for the second brake actuator can be individually controlled.

21. The method as claimed in claim 12, wherein the traction control system (ASR) is automatically activated if an inadmissible drive slip at the first drive wheel and/or at the second drive wheel of the at least one driven axle (HA) has been established.

22. A vehicle, comprising:
a traction vehicle of a traction vehicle/semitrailer combination with a control system, wherein the control system is controlled by performing the following:
a) controlling, by a drive control system, a drive motor that drives at least one driven axle (HA) having a first drive wheel and a second drive wheel,
b) driving, via the drive motor, a differential gear mechanism, which is between the first drive wheel and the second drive wheel,
c) controlling, by a brake control system, a brake device that has a first brake actuator for the first drive wheel and a second brake actuator for the second drive wheel,
d) providing a steering brake function, with which a steering action on the vehicle is provided by selectively controlling the first brake actuator and/or the second brake actuator of the at least one driven axle (HA),
e) guiding, via a traction control system (ASR), an inadmissible drive slip at the first drive wheel and/or at the second drive wheel of the at least one driven axle (HA) back to a permissible drive slip by:
e1) engaging in the drive control of the drive motor, wherein the drive power of the drive motor is reduced, and/or by
e2) engaging in the brake control system of the brake device, wherein a drive wheel which has inadmissibly great drive slip, is selectively braked by the first drive wheel and/or the second drive wheel;
f) dispensing with engagement in the brake control system of the brake device for the traction control system (ASR), when the steering brake function is active or has been activated at the at least one driven axle (HA) and when the traction control system (ASR) is then activated at the at least one driven axle (HA).
